(19) United States
(12) Patent Application Publication
(10) Pub. No.: US 2026/0116210 A1
(43) Pub. Date: Apr. 30, 2026

(54) VEHICLE TORQUE EQUALIZATION

(71) Applicant: Daimler Truck North America LLC, Portland, OR (US)

(72) Inventors: Brendan RIEBLE, Portland, OR (US); Lucas JUNG, Neustadt an der Weinstraße (DE)

(21) Appl. No.: 19/373,424

(22) Filed: Oct. 29, 2025

Related U.S. Application Data
(60) Provisional application No. 63/713,349, filed on Oct. 29, 2024.

(51) Int. Cl. B60L 15/20; B60K 1/02; B60K 17/34

(52) U.S. Cl. CPC B60L 15/20; B60K 1/02; B60K 17/34; B60L 2240/423; B60L 2240/46

(57) ABSTRACT

Aspects include a system and method of operating a motor vehicle including a first drive axle assembly and a second drive axle assembly, including determining a first torque integral of a first torque applied to a first drive axle of the first drive axle assembly by a first motor of the first drive axle assembly over a time period, and determining a second torque integral of a second torque applied to a second drive axle of the second drive axle assembly by a second motor of the second drive axle assembly over the time period. Further, the aspects include generating a first and second torque outputs using the first motor of the first drive axle assembly and the second motor of the second drive axle assembly, respectively, wherein the first and second torque outputs are based at least in part on the first torque integral and the second torque integral.

### CROSS-REFERENCE TO RELATED APPLICATION

This patent application claims the benefit of U.S. Provisional Application No. 63/713,349, filed on Oct. 29, 2024, titled “VEHICLE TORQUE EQUALIZATION.” The disclosure of the prior application is hereby incorporated by reference in its entirety.

### TECHNICAL FIELD

The present disclosure relates generally to control of vehicular powertrains and, more particularly, to systems and methods for operating motor vehicles equipped with two or more traction motors.

### BACKGROUND

Motor vehicles, including passenger cars, sport utility vehicles, commercial trucks, buses, construction equipment, and other platforms, may be configured with a powertrain that provides motive power to one or more driven axles. Increasingly, vehicle powertrains are configured with two or more traction motors (e.g., front and rear axle drive units; dual motors on a common axle; or multiple motors dedicated to independent wheel-ends). Multi-motor configurations can provide benefits such as improved traction, enhanced performance, redundancy, and opportunities for energy recuperation during braking events.

Coordinating operation of multiple traction motors in dynamic driving conditions can present challenges. For example, variations in motor characteristics, inverter controls, gear ratios, tire rolling radii, thermal states, and state-of-charge constraints may cause unequal torque sharing, suboptimal efficiency, or driveline windup. Transient road conditions (e.g., low friction surfaces, split-u events, grade changes), as well as vehicle state inputs (e.g., steering angle, yaw rate, wheel speed, and longitudinal/lateral acceleration), may further complicate real-time control of torque commands across motors.

Without effective supervisory coordination, multi-motor powertrains can exhibit operational inefficiencies such as unnecessary electrical or mechanical losses, uneven component loading and wear, and reduced energy recuperation during regenerative braking. Additional effects can include undesired thermal excursions, increased NVH (noise, vibration, and harshness), and reduced drivability or stability during tip-in, tip-out, launch, and traction-limited maneuvers. These conditions can contribute to higher operating costs, reduced component life, and inconsistent vehicle responses perceived by the driver.

### SUMMARY

The following presents a simplified summary of one or more implementations of the present disclosure to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In some aspects, the techniques described herein relate to a system of operating a motor vehicle including a first drive axle assembly, a second drive axle assembly, and a controller storing instructions in non-transitory memory that, when executed, cause the controller to perform one or more actions including: determine a first torque integral of a first torque applied to a first drive axle of the first drive axle assembly by a first motor of the first drive axle assembly over a time period, determine a second torque integral of a second torque applied to a second drive axle of the second drive axle assembly by a second motor of the second drive axle assembly over the time period, generate a first torque output using the first motor of the first drive axle assembly, and generate a second torque output using the second motor of the second drive axle assembly, wherein the first and second torques are based at least in part on the first torque integral and the second torque integral.

In some aspects, the techniques described herein relate to a method of controlling a motor vehicle powertrain including: operating the motor vehicle powertrain in a dynamic torque split mode where a first torque output via a first motor to a first drive axle and a second torque output via a second motor to a second drive axle include torque outputs; and responsive to an indication that a tire or tires associated with the first drive axle or the second drive axle have a tire diameter that is below a threshold tire diameter, controlling an operation of at least one of the first motor and the second motor as a function of which tire or tires have tire diameters below the threshold tire diameter.

In some aspects, the techniques described herein relate to a system including: a first drive axle assembly; a second drive axle assembly; and a controller storing instructions in non-transitory memory that, when executed, cause the controller to: allocate a first torque output to a first drive axle of the first drive axle assembly and a second torque output to a second drive axle of the second drive axle assembly as a function of total torque applied to the first drive axle over a predetermined time period and total torque applied to the second drive axle over the predetermined time period, such that a difference between the total torque applied to the first drive axle and total torque applied to the second drive axle is minimized over time.

Additional advantages and novel features relating to implementations of the present disclosure will be set forth in part in the description that follows, and in part will become more apparent to those skilled in the art upon examination of the following or upon learning by practice thereof.

### BRIEF DESCRIPTION OF THE DRAWINGS

FIG. 1 is a schematic view of a motor vehicle powertrain comprising independently driven axles, according to an example.

FIGS. 2A-2C are a flow chart of a method for controlling a vehicle powertrain, according to an example.

FIG. 3 is a flow chart of a method for controlling a vehicle powertrain, according to an example.

FIG. 4 is a chart of a first torque output over time and, for comparison purposes, a chart of a second torque output over time, according to an example.

FIG. 5 is a schematic view of wheels of a motor vehicle powertrain, according to an example.

### DETAILED DESCRIPTION

Motor vehicles that employ controlled drive axle assemblies (e.g., a first drive axle assembly and a second drive axle assembly), each with its own traction motor and geartrain, enable granular control of tractive effort across axles. However, conventional control strategies typically address instantaneous torque delivery to meet driver demand or vehicle dynamics constraints without accounting for cumulative torque applied over time at each axle. As a result, multi-motor powertrains can experience unequal cumulative torque application across axles, which correlates with uneven component wear (e.g., tire tread wear, inverter/motor duty cycles) and operational inefficiencies.

Unequal cumulative torque at different axles manifests as differential tire wear, increased maintenance frequency, reduced vehicle uptime, and potential degradation of drivability and efficiency as tire diameters diverge. Existing systems generally lack a supervisory mechanism that tracks axle-specific torque history and adapts torque splits to proactively minimize lifetime wear imbalances under real-world conditions (including traction events, gear changes, recuperation, and reverse operation). Accordingly, there is a need for a coordinated control approach that continuously accounts for total torque applied to each axle and dynamically adjusts torque allocation to mitigate differential wear while respecting safety, performance, and efficiency constraints.

The present disclosure provides a technical solution that operates the powertrain in a torque equalization (dynamic torque split) mode. A controller determines, for each independently driven axle, a torque integral representing the total (e.g., absolute) torque applied over a defined integration interval (e.g., from an initial time t₀ to t−ts), and then allocates instantaneous torque outputs to the motors as a function of both the total torque output request and the relative magnitudes of the torque integrals, so as to minimize the difference between axle torque integrals over time. The controller can further infer tire diameter from wheel/motor speed and gear ratio (and/or tire pressure monitoring system (TPMS) data) and condition torque commands when estimated tire diameter falls below a threshold and can transition to a fallback mode when higher-priority drivetrain requests (e.g., traction loss, anti-lock braking system (ABS), stability, thermal or power limits) require overriding equalization. This architecture generalizes to any number of axles and motors, improves component life by proactively equalizing wear, and maintains vehicle performance through compensatory allocation, thresholding, and mode management.

In further examples, the integration interval can be implemented as a moving window of fixed length (e.g., hours, days, or miles), an exponentially weighted moving average that emphasizes recent torque (with a configurable decay constant), and/or a policy-based window that resets at ignition/key cycles, at completion of a trip, or upon satisfaction of diagnostics conditions. These alternatives can be selected to balance responsiveness to recent events with preservation of lifetime wear history.

### Overview of the Disclosed Technology

Motor vehicles (such as a car, truck, semi-trailer truck, etc.) include powertrains that generate mechanical power and use the mechanical power to propel the motor vehicle. The powertrain can include a plurality of independently controlled drive axle assemblies (for example, a first drive axle assembly and a second drive axle assembly). Each drive axle assembly can include a drive axle coupled to a set of wheels (for example, one or more left wheel(s) and one or more right wheel(s)). Each drive axle assembly can further include at least one motor that can impart torque on the set of wheels via the drive axle to at least partially propel the vehicle. In some examples, the motors can be electric motors (which are also referred to herein as “e-motors”). In one example, if the powertrain includes two drive axle assemblies, a first motor can be coupled to the first drive axle and a second motor can be coupled to the second drive axle. In this way, the first drive axle and the second drive axle can be independently driven such that different amounts of torque can be applied to the first and second sets of wheels, thereby allowing for more granular control of the motor vehicle. Although the example is described as including two drive axles, other examples of the powertrain can include any number of drive axles (for example, three, four, five, six, seven, eight, nine, ten, etc.) and a corresponding number of motors, though it is understood that not every axle with corresponding wheels necessarily includes a motor.

In some examples, the application of different amounts of torque to different drive axles can result in uneven component wear. For example, each wheel of the motor vehicle can include a tire with a tire tread that contacts a ground surface. The tire tread can wear down over time as the motor vehicle travels across the ground surface. Due to different motors driving different axles, differential application of torque to separate drive axles over time can result in differential wear of tires associated with each axle. Other components can similarly be impacted differentially, to some extent, due to differential torque application over time to separate axles.

It is desirable to avoid uneven component wear (for example, tire wear) in order to increase the usable lifespan of the component(s) (e.g., tires), increase motor vehicle uptime, and/or reduce the frequency of required maintenance activities. Thus, there is an unmet need to proactively minimize and/or prevent differential component wear (e.g., tire wear) as a function of drive time and driving conditions.

### Examples of the Disclosed Technology

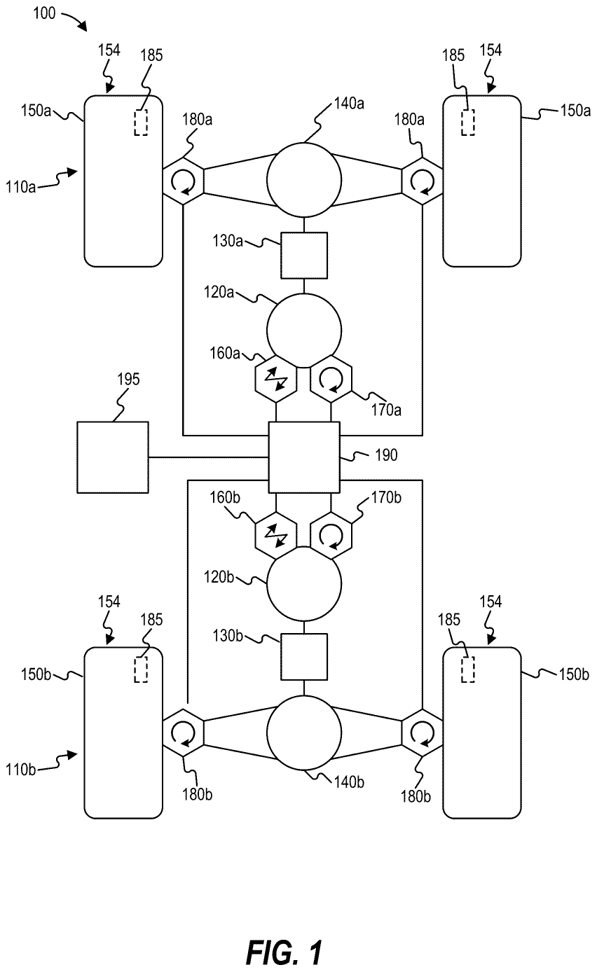

Referring now to FIG. 1, an example motor vehicle powertrain 100 includes a first independently controlled drive axle assembly 110a and a second independently controlled drive axle assembly 110b. Although only two drive axle assemblies 110a, 110b are shown, the motor vehicle powertrain 100 can include any number of drive axle assemblies (for example, three, four, five, six, or more drive axle assemblies). In some examples, the motor vehicle powertrain 100 can be a powertrain of an autonomous vehicle (e.g., a battery electric autonomous vehicle). As used herein, the term “autonomous vehicle” refers to an SAE Level 1, 2, 3, 4, or 5 autonomous vehicle. In some examples, the autonomous vehicle can be an SAE Level 4 autonomous vehicle or an SAE Level 5 autonomous vehicle.

In an aspect, a motor vehicle powertrain 100 includes the first drive axle assembly 110a configured to selectively transmit torque to a first set of wheels 150a. The first drive axle assembly 110a can include one or more traction devices, such as a first motor 120a, operatively coupled to the first set of wheels 150a through one or more torque transmission elements. By way of non-limiting example, the first drive axle assembly 110a can include: a first motor 120a; a first gearbox 130a having an input operatively coupled to an output of the first motor 120a and an output operatively coupled to a first drive axle 140a; and the first set of wheels 150a coupled to the first drive axle 140a. In some aspects, the first gearbox 130a includes a fixed ratio reduction, a multi-speed gearset (e.g., synchronized, dog, or planetary), a differential, one or more wheel-end reductions, and/or one or more selectively engageable torque transfer devices (e.g., clutches, disconnects, or locking differentials). In other aspects, the first motor 120a is integrated into a unitary drive module with the first gearbox 130a, is coupled directly to the first drive axle 140a without an intermediate gearbox, or is implemented as one or more in-wheel or wheel-end motors coupled directly to the first set of wheels 150a (e.g., hub motors).

In implementations with hub motors or per-wheel drive, per-wheel equalization of cumulative torque may induce undesired yaw moments during straight-line driving or on-center steering. Accordingly, in such implementations per-wheel equalization can be constrained by vehicle dynamics criteria (e.g., maintaining a commanded yaw rate within tolerance, aligning left/right wheel torques on an axle within a steering-dependent bound), or disabled except when an active yaw control system commands compensatory actions. These constraints ensure that any left/right per-wheel allocations do not compromise stability, steering feel, or tire friction reserve

The first motor 120a can be any device configured to generate tractive torque, including without limitation an electric machine (e.g., permanent magnet synchronous, induction, switched reluctance), an internal combustion engine coupled through a transmission, a hydraulic or pneumatic motor, or a combination thereof. Although the illustrated aspect depicts a single first motor 120a, the first drive axle assembly 110a can include multiple traction motors arranged in parallel or series, configured to impart torque on the same drive axle 140a and/or on individual wheels of the first set of wheels 150a. Components of the first drive axle assembly 110a can be arranged coaxially or off-axis, and can be packaged as a single drive unit or as distributed elements.

The first set of wheels 150a can include any number of wheels and tires appropriate for the vehicle platform, and the wheels can be steerable or non-steerable, single or dual (e.g., duals on heavy-duty axles). The first drive axle assembly 110a can further include sensors and actuators, such as torque, speed, and temperature sensors, wheel speed sensors, tire pressure monitoring systems, and actuators for gear selection, clutch engagement, or axle disconnects. Unless otherwise specified, references to the first drive axle assembly 110a encompass variants having different gear ratios, differential types, torque vectoring devices, and decoupling mechanisms.

In additional aspects, a motor vehicle powertrain can include any combination of powered and unpowered axle assemblies. For example, a powertrain can comprise two or more independently controlled drive axle assemblies (e.g., 4×2, 4×4, 6×2, 6×4, 6×6, 8×2, 8×4, 8×6, 8×8 configurations), where each drive axle assembly includes any suitable number and type of motors and torque transmission elements. One or more axle assemblies can be unpowered (e.g., lift axles or tag axles) and may be steerable or non-steerable. Different axle assemblies within the same vehicle can employ different numbers or types of motors, different gearbox architectures, and different overall geartrain ratios. As such, the present disclosure encompasses homogeneous and heterogeneous axle configurations, including tandem drive axles with inter-axle differentials, mixed hub-motor and central-drive layouts, and architectures that selectively couple or decouple one or more axles or wheels from propulsion.

In some aspects, the first gearbox 130a is a multi-speed transmission configured to shift among a plurality of discrete gears, each gear providing a different gear ratio. The first drive axle assembly 110a defines an overall gear ratio (also referred to as an overall geartrain ratio) between the motor 120a and the first set of wheels 150a. The overall gear ratio accounts for the instantaneous gear ratio of the first gearbox 130a, any fixed reductions between the motor 120a and the first set of wheels 150a, and any differential or wheel-end reductions. Accordingly, the overall gear ratio represents the ratio of revolutions of an output rotor shaft of the motor 120a to revolutions of the wheels of the first set of wheels 150a.

Each wheel of the first set of wheels 150a includes a tire having a tread 154 that contacts the ground surface. The tread 154 wears over time as the motor vehicle travels. In the configuration illustrated, the first set of wheels 150a includes two wheels, each coupled to a respective end of the first drive axle 140a. However, a drive axle assembly as described herein can include any suitable number of wheels and corresponding tires (e.g., one, two, three, four, five, six, seven, eight, nine, ten, or more), and different axle assemblies of the motor vehicle powertrain 100 can have different numbers of wheels. In all cases, the first motor 120a is indirectly coupled to the first set of wheels 150a through the first gearbox 130a and the first drive axle 140a to apply tractive torque to the wheels.

The first drive axle assembly 110a can include a first torque sensor 160a operatively coupled to the first motor 120a and configured to measure torque output by the first motor 120a. In some examples, the measured motor torque is multiplied by the overall gear ratio of the first drive axle assembly 110a (which includes the gear ratio of the first gearbox 130a, any fixed gear ratios, and any differential or wheel-end ratios) to estimate the torque applied at the first drive axle 140a and/or at the first set of wheels 150a.

The first drive axle assembly 110a can optionally include a first motor speed sensor 170a coupled to the output of the first motor 120a and configured to measure the motor's rotational speed. In some examples, the measured motor speed is multiplied by the inverse of the overall gear ratio of the first drive axle assembly 110a to estimate the rotational speed of the first drive axle 140a and, where appropriate, the rotational speed of the first set of wheels 150a.

The first drive axle assembly 110a can optionally include one or more first wheel speed sensors 180a configured to measure the rotational speed of the first set of wheels 150a. Each wheel speed sensor 180a can be mechanically or operatively coupled to a corresponding wheel of the first set of wheels 150a. In the illustrated configuration, two wheel speed sensors 180a are provided, each coupled to a respective wheel of the first set of wheels 150a.

The second drive axle assembly 110b can be substantially similar to the first drive axle assembly 110a. For example, the second drive axle assembly 110b can include a second motor 120b, a second gearbox 130b configured to shift among multiple gears, a second drive axle 140b, a second set of wheels 150b, a second torque sensor 160b, a second motor speed sensor 170b, and one or more second wheel speed sensors 180b. The second drive axle assembly 110b can define an overall gear ratio between an output rotor of the second motor 120b and wheel hubs of the second set of wheels 150b. Accordingly, the second drive axle assembly 110b can have a structure and functionality similar to the first drive axle assembly 110a.

One or more wheels of the first set of wheels 150a and the second set of wheels 150b can include a tire pressure monitoring system 185 (TPMS). In the illustrated configuration, each wheel includes a corresponding TPMS 185. In some examples, the TPMS 185 is a direct TPMS that includes a pressure sensor located within the tire or mounted on the valve stem to measure tire pressure, and a transmitter configured to relay tire pressure data to a controller of the motor vehicle powertrain 100. In other examples, the TPMS 185 is an indirect TPMS that estimates tire pressure without pressure sensors by using signals from existing wheel speed sensors (e.g., wheel speed sensors 180a and/or 180b) and inferring pressure based on wheel speed differentials and/or peak tire resonance.

The motor vehicle powertrain 100 can include one or more controllers configured to control torque output of each motor (e.g., the first and second motors 120a, 120b). Although a single controller 190 is depicted for clarity, any number of controllers can be used (e.g., two, three, four, five, six, seven, eight, nine, ten, or more). In some implementations, functionality attributed to the controller 190 is distributed among multiple controllers. For example, one controller can determine a torque output request and another controller can command generation of the requested torque by one or more electric motors (e.g., the first and/or second motors 120a, 120b). In such implementations, the illustrated controller 190 can be one of the plurality of controllers.

The controller 190 can be implemented as, for example, a field-programmable gate array (FPGA), an application-specific integrated circuit (ASIC), an electronic control unit (ECU), or another computing device. The controller 190 can include a processor configured to execute computer-readable instructions, receive and process sensor data, and generate output signals to control actuators, including actuators that drive the first motor 120a and/or the second motor 120b. The controller 190 can further include memory (e.g., read-only memory (ROM) and random access memory (RAM) in any combination) for storing computer-readable instructions, received sensor data, vehicle operating parameters, and other values (e.g., torque integrals determined by the processor). In examples where the motor vehicle powertrain 100 includes multiple controllers, each controller can have a similar structure or functionality as the controller 190; alternatively, one or more of the controllers can differ in structure and/or function from the controller 190.

In implementations with a single controller 190, the controller can include multiple output channels, each operatively coupled to a corresponding actuator such as a traction motor. For example, a first output of the controller 190 can drive control signals to the first motor 120a and a second output can drive control signals to the second motor 120b. In implementations with multiple controllers, the first motor 120a and the second motor 120b can be assigned to different respective controllers. In other implementations with multiple controllers, each of the first motor 120a and the second motor 120b can interface with two or more controllers, such as a supervisory controller that determines torque targets for the motors and a motor-control controller that generates the low-level control signals for the motors 120a, 120b.

The controller 190 (or at least one controller in a multi-controller architecture) can generate and transmit output signals indicating the torque to be produced by each of the first motor 120a and the second motor 120b. The controller 190 can communicate with the motors via wired, wireless, or hybrid links. In some examples, the controller 190 (or another controller) can provide additional outputs to other vehicle components, such as a display or human-machine interface.

The controller 190 (or at least one controller in a multi-controller architecture) can receive sensor data from vehicle powertrain sensors, such as torque sensors, motor speed sensors, and wheel speed sensors. Generally, the controller 190 processes inputs from these sensors and issues commands to actuators (e.g., the electric motors). In a single-controller configuration, the controller 190 can include multiple input channels, each coupled to a respective sensor of the powertrain 100. For example, inputs can be coupled to the first torque sensor 160a, the second torque sensor 160b, the first motor speed sensor 170a, the second motor speed sensor 170b, at least one of the first wheel speed sensors 180a, and at least one of the second wheel speed sensors 180b. In multi-controller configurations, sensors may be distributed among controllers. For instance, a first controller can ingest sensor signals and compute torque targets for the motors, and a second controller can receive those targets and generate motor control signals for the first and second motors 120a, 120b. In all cases, the controller 190 (or the relevant controller(s)) can be communicatively coupled to the sensors via wired and/or wireless connections and can include additional inputs for other vehicle sensors or subsystems.

As disclosed herein, the controller 190 (or at least one controller) can command the first motor 120a and the second motor 120b pursuant to logic (e.g., executable instructions stored in memory) that substantially equalizes, over a defined time period, the total torque applied to the first drive axle 140a and the second drive axle 140b. By doing so, differences in component wear attributable to axle-specific torque application can be reduced. For example, tire wear associated with the first set of wheels 150a can be maintained substantially equal to tire wear associated with the second set of wheels 150b over time. In particular, the controller can integrate the torque applied to the first drive axle 140a over a time period to obtain a first torque integral and integrate the torque applied to the second drive axle 140b over the same time period to obtain a second torque integral. Because cumulative axle torque correlates with tire tread wear, the controller can operate the powertrain 100 to reduce, prevent, or minimize uneven tire wear between the first set of wheels 150a and the second set of wheels 150b.

Minimizing uneven component wear (e.g., tire tread wear) provides multiple benefits. Maintaining substantially equal tire wear can extend tire life and the life of associated powertrain components, reduce the frequency of tire rotations or replacements, increase vehicle uptime, and lower maintenance costs. Additionally, by automatically equalizing wear, inspections for tire tread wear can be reduced, which is particularly advantageous for autonomous vehicles that lack a human driver to perform routine tire checks.

In some implementations, the controller 190 (or another controller) operates in a torque equalization mode (also referred to as a dynamic torque split mode). In this mode, the controller independently regulates each motor (e.g., motors 120a, 120b) so that the cumulative torque applied over time by each motor tends toward equality. The controller can first determine the first and second torque integrals, where the first torque integral quantifies torque applied by the first motor 120a to the first drive axle 140a over a selected time period and the second torque integral quantifies torque applied by the second motor 120b to the second drive axle 140b over the same period. The time period can be, for example, the life of the vehicle, the life of the tires, the elapsed time since a qualifying maintenance event (e.g., tire replacement or rotation), the duration of a trip, or a preset interval (e.g., day, week, month, year). In some examples, the integration window is reset upon receiving an indication that the tires were replaced or rotated, that an axle was serviced or swapped, or upon another qualifying maintenance event.

In some examples, the first torque integral and the second torque integral can be integrals of the absolute value of torque applied to the first and second drive axles 140a, 140b, respectively. In such examples, integrating the absolute value of applied torque can help account for any tire tread wear that occurs when the motor vehicle travels in reverse. Additionally or alternatively, integrating the absolute valve of applied torque can help account for any tire tread wear that occurs during recuperation (e.g., regenerative braking), when a negative torque is applied to recharge the battery (or batteries) of the motor vehicle. Thus, integrating the absolute valve of applied torque can help beneficially account for tire tread wear caused by the motor vehicle traveling either in forward or in reverse and/or account for the motors 120a, 120b operating in either a traction mode or a recuperation mode.

In some examples, the controller 190 (or at least one of a plurality of controllers) can determine the first torque integral by determining a Riemann sum that approximates the first torque integral. For example, the controller 190 (or at least one of a plurality of controllers) can sample a signal received from the first torque sensor 160a at a first frequency (for example, 100 Hz), multiply the value of the sampled signal by a first sampling period (for example, the reciprocal of the first frequency), and sum the products to arrive at the Riemann sum. In some examples, the first sampling period can be in a range from 10 milliseconds to 20 milliseconds. In some examples, since the first torque sensor 160a measures torque at the output of the first motor 120a instead of at the first drive axle 140a, the value of the sampled signal can be further multiplied by the overall gear ratio of the first drive axle assembly 110a to determine the amount of torque applied to the first drive axle 140a and/or the first set of wheels 150a.

Similarly, the controller 190 (or at least one of a plurality of controllers) can determine the second torque integral by determining a Riemann sum that approximates the second torque integral. For example, the controller 190 (or at least one of a plurality of controllers) can sample a signal received from the second torque sensor 160b at a second frequency (for example 100 Hz), multiple the value of the sampled signal by a second sampling period (for example, the reciprocal of the second frequency), and sum the products to arrive at the Riemann sum. In some examples, the second sampling period can be in a range from 10 milliseconds to 20 milliseconds. Additionally or alternatively, in some examples, the second sampling period can be equal to the first sampling period. In some examples, since the second torque sensor 160b measures torque at the output of the second motor 120b instead of at the second drive axle 140b, the value of the sampled signal can be further multiplied by the overall gear ratio of the second drive axle assembly 110b to determine the amount of torque applied to the second drive axle 140b and/or the second set of wheels 150b.

The controller 190 (or at least one of a plurality of controllers) in the torque equalization mode can be configured to determine a total torque output request for the motor vehicle. The total torque output request can be a total amount of instant torque required to instantaneously accelerate or decelerate the motor vehicle to a particular speed, meet a particular acceleration or deceleration target, or to overcome resistance without accelerating or decelerating the vehicle in order to maintain a substantially constant vehicle speed. The controller 190 can determine the total torque output request based on any combination of sensor data (for example, camera, radar, lidar, or GPS data), user input (for example, a degree of depression of a gas pedal), a predetermined parameter, a user-defined parameter (for example, cruise control), and so on.

In some examples, the motor vehicle can include an autonomous driving module 195. The autonomous driving module 195 can be configured to interface with the controller 190 to operate the motor vehicle without direct human input. The autonomous driving module 195 can be configured to receive input from any combination of sensors (for example, the rotational speed sensors 180a and 180b, cameras, lidar sensors, radar sensors, ultrasonic sensors, GPS telemetry sensors, environmental sensors), receivers (for example, a receiver in communication with a server), or other modules of the motor vehicle. In some examples, the autonomous driving module 195 can determine the total torque output request and provide this value to the controller 190. For example, the autonomous driving module 195 can determine the total amount of torque required to propel the motor vehicle in a particular direction (for example, in a direction away from an obstacle detected by a lidar sensor, a radar sensor, a camera, and/or an ultrasonic sensor), along a particular path (for example a path determined based on GPS data received from a GPS telemetry sensor), and/or at a particular desired speed and/or acceleration (for example, based on a determination from GPS data received from a GPS telemetry sensor that the motor vehicle is traveling on a road with a particular speed limit). In some examples, the controller 190 can be configured to include the functionality of the autonomous driving module 195.

The controller 190 (or at least one of a plurality of controllers) in the torque equalization mode can be configured to then determine a first desired torque output (which is also referred to herein as a “first desired dynamic torque output,” a “first dynamic torque output,” and/or a “first target torque output”) for the first motor 120a to output and a second desired torque output (which is also referred to herein as a “second desired dynamic torque output,” a “second dynamic torque output,” and/or a “second target torque output”) for the second motor 120b to output. As used herein, the “desired torque output” refers to a torque output for a given motor that is based on a combination of the torque integrals (e.g., the first torque integral and the second torque integral) and the total torque output request. The desired torque output is selected such that the application of the desired torque output by a corresponding motor will reduce (e.g., minimize) a difference in the torque integrals corresponding to the different axles of the vehicle over time. However, it should be understood that, in some examples, the desired torque output is not necessarily equal to the amount of torque actually output by the corresponding motor.

In a two axle/two motor system, for example, each one of the first desired torque output and the second desired torque output can be determined based on some combination of the first torque integral, the second torque integral, and the total torque output request. In some examples, the first desired torque output can be equal to the total torque output request, multiplied by the inverse of the sum of the reciprocal of the first torque integral and the reciprocal of the second torque integral, and divided by the first torque integral. For example, the first desired torque output at the time/(τ_{1,des}(t)) (for example, the current time) can be given by:

$${τ}_{1 , des} ( t ) = {τ}_{tot} ( \frac{{[ {\sum }_{n = 1}^{m} \frac{1}{{\int }_{{t}_{0}}^{t - {t}_{s}} {τ}_{n} ( t ) dt} ]}^{- 1}}{{\int }_{{t}_{0}}^{t - {t}_{s}} {τ}_{1} ( t ) dt} ) \qquad ( 1 )$$

wherein “τₜₒₜ” is the total torque output request, “τ₁(t)” is the torque output of the first motor 120a at time t, “τₙ(t)” is the torque output of the n^{th} motor at time t, “n” is the summation index, “m” is the number of independently controlled drive axle assemblies of the motor vehicle powertrain 100, “tₛ” is the sampling period, and “t₀” is an initial time (for example, beginning of the life of the vehicle, the time of the last qualifying maintenance event (for example, the time of the last tire replacement, tire maintenance event, axle replacement, and/or axle maintenance)). In such examples, the controller 190 (or at least one of a plurality of controllers) can be further configured to determine the second desired torque output in similar fashion as discussed immediately below.

In some examples, the time t can be equal to the present time. In some examples, due to communication delays between the controller 190 and other components of the vehicle, the time t can be offset from the present time by a communication delay period in a range from 10 milliseconds to 20 milliseconds. Thus, the first torque integral can be integrated over a time period spanning t₀ to time t, which may or may not be offset by the communication delay period. However, in some examples, since the communication delay period can be considered negligible, some examples of the controller 190 do not need to account for the communication delay period.

In some examples, the second desired torque output can be based on any combination of the relative magnitudes of the first torque integral, the second torque integral, and the total torque output. In some examples, the second desired torque output can be equal to the total torque output request, multiplied by the inverse of the sum of the reciprocal of the first torque integral and the reciprocal of the second torque integral, and divided by the second torque integral. For example, the second desired torque output at time t (τ_{2,des}(t)) can be given by:

$${τ}_{2 , des} ( t ) = {τ}_{tot} ( \frac{{[ {\sum }_{n = 1}^{m} \frac{1}{{\int }_{{t}_{0}}^{t - {t}_{s}} {τ}_{n} ( t ) dt} ]}^{- 1}}{{\int }_{{t}_{0}}^{t - {t}_{s}} {τ}_{2} ( t ) dt} ) \qquad ( 2 )$$

Hence, the methodology herein described aims to substantially equalize the torque applied to each axle over a period of time, which can include supplying a greater amount of torque to a first axle and a correspondingly lesser amount to a second axle when it is determined that the second axle has accumulated more total torque than the first axle, and vice versa. In this way, a ratio of the first desired torque output and the second desired torque output can be inversely related to a ratio of the first torque integral and the second torque integral.

In some examples, the first desired torque output and the second desired torque output are determined using one or more lookup tables. For example, a first lookup table can include a plurality of values for the first desired torque output indexed by a corresponding one of a plurality of differences between the first torque integral and the second torque integral. In such examples, the first desired torque output can be obtained by calculating the difference between the first torque integral and the second torque integral and using that difference to look up the corresponding first desired torque output in the lookup table. In some examples, a second lookup table can be used to look up the second desired torque output based on the difference between the first torque integral and the second torque integral. In some examples, the values of the first lookup table (and/or any lookup table herein described) can be empirically determined. In some examples, using a lookup table to determine desired torque outputs may be faster and/or less computationally expensive than using the equations herein disclosed, and/or may reduce overcompensation.

By requesting the first and second motors 120a, 120b to output the desired torque outputs, the controller 190 (or at least one of a plurality of controllers) can command the first motor 120a and the second motor 120b to substantially equalize, over time, the total amount of torque applied by the first motor 120a and the second motor 120b. Doing so promotes more even component wear (for example, tire tread wear) between the first set of wheels 150a and the second set of wheels 150b. Thus, requesting the first and second motors 120a, 120b to output the desired torque outputs can help address discrepancies in the relative amounts of torque applied over time to reduce uneven component wear.

Additionally or alternatively, the controller 190 can enforce constraints and priorities while requesting the desired torque outputs, including adherence to axle/motor torque limits, traction and stability requirements, regenerative braking availability, thermal derating, and energy efficiency targets. In some examples, the controller 190 can implement asymmetric biasing (e.g., to favor a more efficient axle when wear is substantially equal) while still converging the torque integrals over the selected time window. The approach generalizes to powertrains having more than two independently controlled axles or wheel-ends, where the controller 190 allocates desired torque outputs to each motor as a function of the set of torque integrals so as to minimize pairwise and/or aggregate differences across the set.

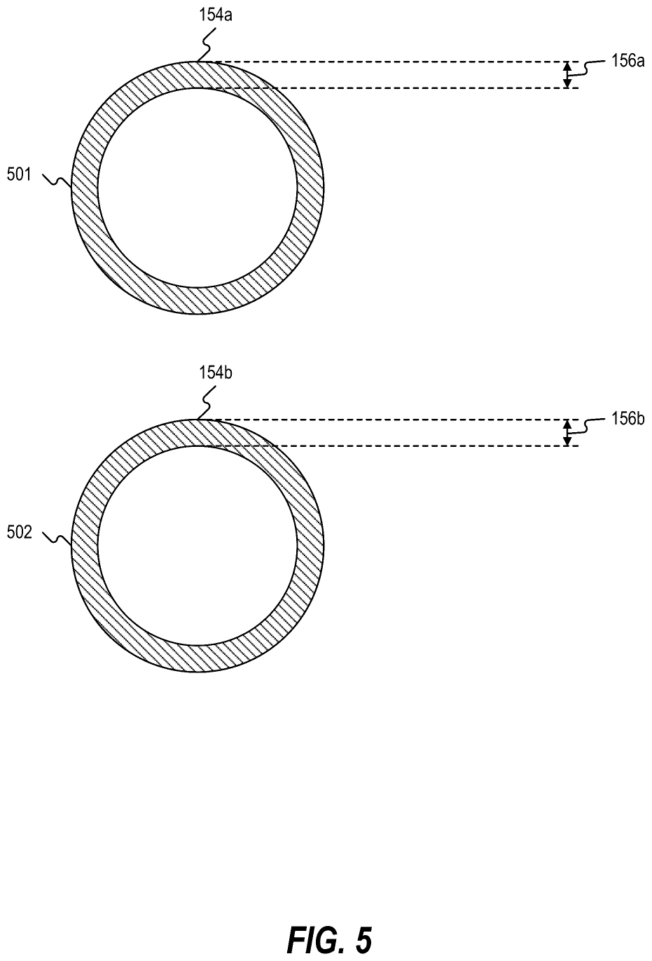

Now referring to FIG. 5, in one example, a wheel 501 of the first set of wheels 150a and a wheel 502 of the second set of wheels 150b can have different amounts of tire tread, which can be accounted for and/or avoided by the torque equalization techniques of the present disclosure. The wheel 501 includes a tire tread 154a. As the tire tread 154a wears down over time, the thickness 156a of the tire tread 154a will decrease. Similarly, the wheel 502 includes a tire tread 154b whose thickness 156b will decrease as the second tire tread 154b is worn down. When the motor vehicle powertrain 100 operates in the torque equalization mode as herein disclosed, torques are applied to the wheels 501, 502 such that the tire tread 154a and the tire tread 154b will wear at the same rate (or at least substantially the same rate). Thus, as shown, their thicknesses 156a, 156b remain substantially equal over time, proactively minimizing or substantially avoiding any difference in tire tread wear. Advantageously, via the use of the torque equalization methodology, tires on different axles may wear at a more even rate, thereby increasing the usable lifespan of the tires, increasing the time between tire maintenance events, and reducing a negative impact to other components that otherwise may be impacted by differential tire wear over time. For example, if differences in tire tread wear are minimized such that the thicknesses 156a, 156b remain substantially equal over time, the motors imparting torque on the wheels 501, 502 will actuate at substantially the same rate, thus equalizing wear on the motors. Additionally, since the motors actuate at substantially the same rate, substantially equal amounts of current will flow through the inverters connected to the motors, thus equalizing wear on the inverters as well.

In some examples, maintaining substantially equal torque integrals further promotes parity in wear and duty cycles across driveline components including differentials, half-shafts, constant-velocity joints, bearings, gear meshes, and brake friction elements (e.g., by harmonizing regenerative versus friction braking contributions across axles). In additional or alternative aspects, equalization can reduce thermal cycling asymmetry between drive units and inverters, leading to improved reliability of power electronics (e.g., reduced junction temperature excursions and current ripple imbalance). While FIG. 5 illustrates an idealized case of equal wear rates, implementations can target a tolerance band (e.g., within a specified percentage difference of tread thickness or torque integral) to account for environmental variability, tire construction differences, and operational constraints. In further examples, other wear proxies—such as estimated tire effective rolling radius, measured tire pressure histories (e.g., via TPMS 185), or motor/inverter cumulative ampere-seconds—can be monitored and incorporated into the equalization objective and/or lookup table indices to improve robustness across platforms and configurations.

Although equalization of tire tread wear is a representative outcome, the same architecture can be configured to equalize lifetime duty or wear proxies across non-tire components, including without limitation drive unit geartrains, bearings, half-shafts, differentials, inverters, and battery modules. In such embodiments, the controller accumulates component-specific measures (e.g., cumulative ampere-seconds, temperature-weighted current, or torque-through-gear reduction) as integrals and allocates torque to reduce differences among such integrals while satisfying vehicle-level constraints.

Referring back to FIG. 1, it should also be understood that Equations 1 and 2, as presented above, show how desired torque outputs are allocated between just the first motor 120a and the second motor 120b in the motor vehicle powertrain 100 having two drive axle assemblies 110a and 110b. However, Equations 1 and 2 can be generalized as shown below in Equation 3 to allocate desired torque outputs among any number of independent drive axle assemblies:

$${τ}_{i , des} ( t ) = {τ}_{tot} ( \frac{{[ {\sum }_{n = 1}^{m} \frac{1}{{\int }_{{t}_{0}}^{t - {t}_{s}} {τ}_{n} ( t ) dt} ]}^{- 1}}{{\int }_{{t}_{0}}^{t - {t}_{s}} {τ}_{i} ( t ) dt} ) \qquad ( 3 )$$

wherein “i” is the i^{th} drive axle assembly of concern, “τᵢ(t)” is the torque output of the motor of the i^{th} drive axle assembly at time t, and “τ_{i,des}(t)” is the desired torque output of the i^{th} motor at time t.

Alternatively, the lookup tables herein described can be generalized to determine desired torque outputs for any number of independent drive axle assemblies. In some examples, a plurality of lookup tables can be implemented, including per-axle tables and/or a single multi-axle table that jointly maps an input state vector to desired torque outputs for each motor. The input state vector can include, without limitation: one or more differences between torque integrals (e.g., pairwise and/or aggregate differences), absolute or normalized torque integrals for each axle, a total torque output request, vehicle speed, road grade, estimated road friction (μ), tire condition indicators (e.g., estimated diameter deltas or pressure from TPMS 185), thermal headroom of drive units and inverters, battery state-of-charge, gearbox states, and stability control status. Interpolation (e.g., linear, bilinear, spline) and, in some aspects, bounded extrapolation can be applied between table breakpoints.

In some examples, the controller 190 (or at least one of a plurality of controllers) may command the first motor 120a and/or the second motor 120b to output an amount of torque that is different than the corresponding desired torque output in view of one or more overriding system or operational considerations (for example, safety issues, maximum torque output limits, collision avoidance, vehicle stability, traction loss, braking (for example, ABS), energy recuperation, tire or other component damage, thermal derating, power limits, driveline protection, or regulatory constraints). In some of these examples, the controller 190 (or at least one of a plurality of controllers) can instead be configured to operate in a “fallback” mode (which is also referred to herein as a “default mode”) in which the torque equalization mode and corresponding methodology are paused/discontinued for some amount of time. Specifically, the controller 190 (or at least one of a plurality of controllers) may switch from operating in the torque equalization mode to operating in the fallback mode, e.g., based on the occurrence of a higher priority drivetrain request (i.e., a request that overrides the request to operate in the torque equalization mode), e.g., a safety or traction loss event. Additionally or alternatively, entry to fallback mode can be triggered by wheel slip thresholds, brake system requests (including ABS modulation or brake-by-wire commands), abnormal sensor diagnostics (e.g., failed torque sensor, implausible wheel speed, TPMS fault), excessive current or temperature, inverter or contactor fault, or a supervisory arbitration policy that prioritizes stability and braking authority over torque equalization. In some examples, fallback mode includes timers and/or event latches to prevent rapid mode switching, and resumes torque equalization automatically upon satisfaction of resumption criteria (for example, stability restored for a dwell time, sensor signals validated, temperatures below thresholds) or upon an explicit resume command. In further aspects, a partial fallback mode can be used in which equalization weighting is reduced but not fully disabled, allowing bias to efficiency or stability while continuing slow convergence of torque integrals within a defined tolerance band.

In some examples, the controller 190 (or at least one of a plurality of controllers) can be configured to receive a request (which is also referred to herein as a “decouple request”) to decouple a motor of a drive axle assembly from its corresponding set of wheels. In response to receiving the decouple request, the controller 190 (or at least one of a plurality of controllers) can generate a command or a signal to a drive axle assembly to decouple its set of wheels from its corresponding motor, such that torque cannot be transferred from the motor to the set of wheels. For example, the controller 190 can command the first drive axle assembly 110a to set the first gearbox 130a into a neutral gear, thereby preventing the first motor 120a from exerting torque upon the first set of wheels 150a. Additionally or alternatively, decoupling can be achieved via one or more mechanisms including: opening a selectable clutch or axle disconnect, commanding a differential disconnect or hub disconnect, issuing a safe-torque-off (STO) to an inverter, opening a high-voltage contactor (where permitted), or commanding zero-torque while mechanically disengaging a gearset. In some aspects, the decouple request can specify a number of axles to decouple and/or identify particular axle(s), and selection logic can prioritize axles with highest torque integrals, lowest available traction, or least efficiency to meet a total torque output request while preserving stability and component limits. Re-coupling can be performed according to synchronization logic (e.g., matching shaft speeds and phase, verifying lubrication/temperature conditions, and satisfying interlock diagnostics) to avoid driveline shock. In further examples, decoupling can be temporary (e.g., for energy efficiency, thermal recovery, or tire-wear mitigation) and coordinated with fallback mode, torque compensation, and equalization objectives so that overall vehicle torque demand is maintained within limits via redistribution to remaining coupled axles.

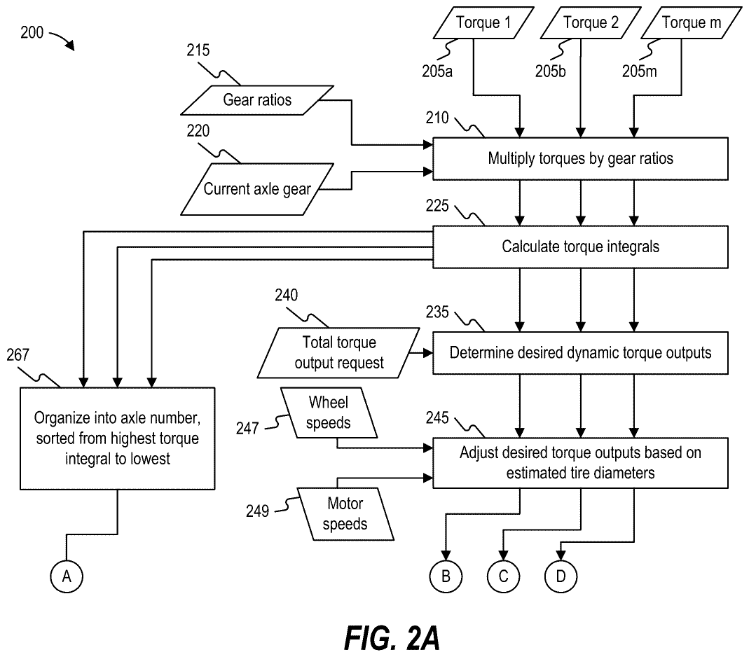

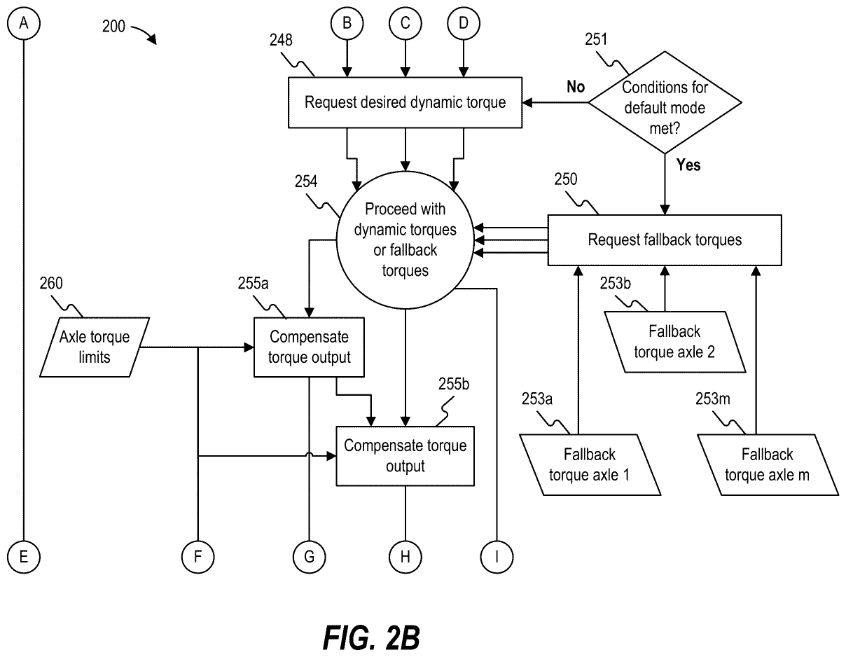

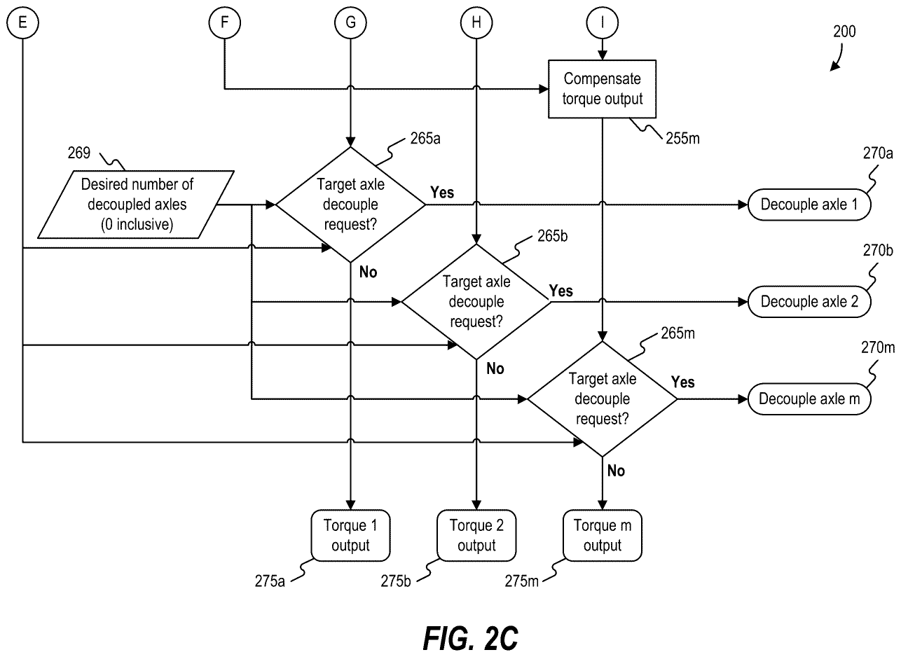

Referring to FIGS. 2A-C, a method 200 for controlling a motor vehicle powertrain (for example, motor vehicle powertrain 100), according to an example, is generalized to account for an arbitrary number m of independently controlled drive axle assemblies (similar to independent drive axle assemblies 110a, 110b shown in FIG. 1), wherein m can be any number greater than one (for example, two, three, four, five, six, seven, eight, nine, ten, etc.). Each independently controlled drive axle assembly can include a motor, a torque sensor coupled to the motor, a motor speed sensor coupled to the motor, a drive axle coupled to the motor, a set of wheels (for example, two wheels) coupled to the drive axle, and at least one wheel speed sensor coupled to at least one wheel of the set of wheels. In some examples, one or more controllers (for example, controller 190) can store and/or process computer-readable instructions for executing the method 200. In FIGS. 2A-C, parallelograms represent inputs, rectangles represent operations, diamonds represent decisions, and ovals represent outputs.

At blocks 205a, 205b, 205m, the torque outputs of a first motor of a first drive axle assembly, a second motor of a second drive axle assembly, and an m^{th} motor of an m^{th} drive axle assembly can be measured to obtain a first torque measurement signal, a second torque measurement signal, and an m^{th} torque measurement signal, respectively. In some examples, the torque outputs can be measured by a torque sensor (for example, any one of torque sensors 160a and 160b). In some examples where at least one of the drive axle assemblies includes a plurality of motors, torque measurement signals for each of the plurality of motors of that drive axle assembly can be obtained.

At block 210, each torque measurement signal (for example, the first torque measurement signal, the second torque measurement signal, and the m^{th} torque measurement signal) can be optionally multiplied by an overall gear ratio of the respective drive axle assembly to determine the amounts of torque exerted upon the respective first, second, and m^{th} drive axle coupled to the corresponding first, second, and m^{th} motors. The overall gear ratio for each drive axle assembly can be the gear ratio between an output rotor of the motor and the wheel hubs of the wheels connected to the drive axle. The overall gear ratios for the first, second, and m^{th} drive axle assemblies can be determined at block 215, respectively. The overall gear ratio can be a function, for example, of the current axle gear of a gearbox of the drive axle assembly, any fixed gear ratios in the geartrain of the drive axle assembly, and/or any differential ratios in the geartrain of the drive axle assembly. The current axle gears of the first, second, and m^{th} gearboxes can be determined at block 220, respectively.

At block 225, the first, second, and m^{th} torque integrals can be calculated by integrating the amounts of torque exerted upon the first, second, and m^{th} drive axles over a time period, for example, a time period spanning from an initial time t₀ to a time equal to t−tₛ. The initial time t₀ can be the beginning of the lifetime of the motor vehicle or a time of a last qualifying maintenance event (for example, a tire rotation or a tire replacement). The time/can be the current time and tₛ can be a sampling period (for example, the inverse of a sampling frequency of a torque sensor). In some examples, the sampling period can be in a range from 10 milliseconds to 20 milliseconds. The torques can be integrated over this time period to determine a first torque integral, a second torque integral, and an m^{th} torque integral, respectively. In some examples, the absolute values of the amounts of torque can be integrated over this time period. As a representative example, a torque integral can be obtained by sampling torque values using a respective torque sensor at a sampling frequency over the time period, multiplying each sampled torque value by the sampling period tₛ, which is the inverse of the sampling frequency, and summing the products in a Riemann sum. The torque integrals can be determined using either a trapezoidal or a rectangular Riemann sum. In some examples where at least one of the drive axle assemblies includes a plurality of motors coupled to a single drive axle, the torque outputs of each of the plurality of motors can be approximated using a Riemann sum, and the Riemann sums can be added together to approximate the total amount of torque applied to the corresponding drive axle.

At block 235, the desired torque outputs for each of the first, second, and m′h motors can be determined. The first, second, and m^{th} desired torque outputs can be determined based at least in part on the torque integrals determined at block 225 (for example, using previously presented Equation 3). However, it should be understood that the equations herein are not the only way desired torque outputs may be obtained. For example, as previously described, the first, second, and m^{th} desired torque outputs can be determined using lookup tables that index desired torque outputs to corresponding differences of torque integrals. To mitigate chattering and overcompensation during rapid transients, the controller can apply one or more of: (i) deadbands on torque-integral differences below a threshold; (ii) hysteresis bands for mode and allocation transitions; (iii) rate limits and slew-rate constraints on desired torque outputs; and (iv) temporal smoothing filters on table outputs or computed allocations.

In some examples, the desired torque outputs for each of the first, second, and m^{th} motors can be determined at block 235 based at least in part on the total torque output request for the motor vehicle powertrain (block 240). The total torque output request can be determined at block 240 based on any combination of sensor data, user input (for example, a degree of depression of a gas pedal), and a predetermined parameter. In some examples, the desired torque outputs for each of the first, second, and m^{th} motors can be determined such that the sum of the desired torque outputs equals the total torque output request. In this way, sufficient torque can be allocated to the first, second, and m^{th} motors to meet the total torque output request. The desired torque outputs are such that, if more torque has been applied to one drive axle over the time period than another drive axle, applying the desired torque outputs via the dynamic torque split mode of operation to each drive axle will serve to substantially equalize the total amounts of torque applied to each drive axle over time.

At block 245, the desired torque outputs for each of the first, second, and m^{th} motors can be adjusted based on the current estimated tire diameters of the first, second, and m^{th} sets of wheels. For example, the current estimated tire diameter for each set of wheels can be determined by dividing the ground speeds of the sets of wheels (estimated at block 247) by the speed of the corresponding motor (measured at block 249 using motor speed sensors 170a and 170b), and further dividing the quotient by the corresponding overall gear ratios (measured at block 215). A difference between an initial tire diameter and the current estimated tire diameter can be determined for each set of wheels. In some aspects, if the difference exceeds a certain threshold value (e.g., a tire wear parameter), the desired torque output for the corresponding motor can be set to zero. However, it should be understood that the desired torque output for the corresponding motor can be compensated in subsequent steps such that the corresponding motor can actually output a non-zero torque. In all cases, accumulation of the torque integrals continues irrespective of temporary de-prioritization of an axle (e.g., due to an inferred low tire diameter, traction loss, thermal derating, or a fallback condition), such that torque applied during these events remains reflected in the corresponding cumulative torque integral

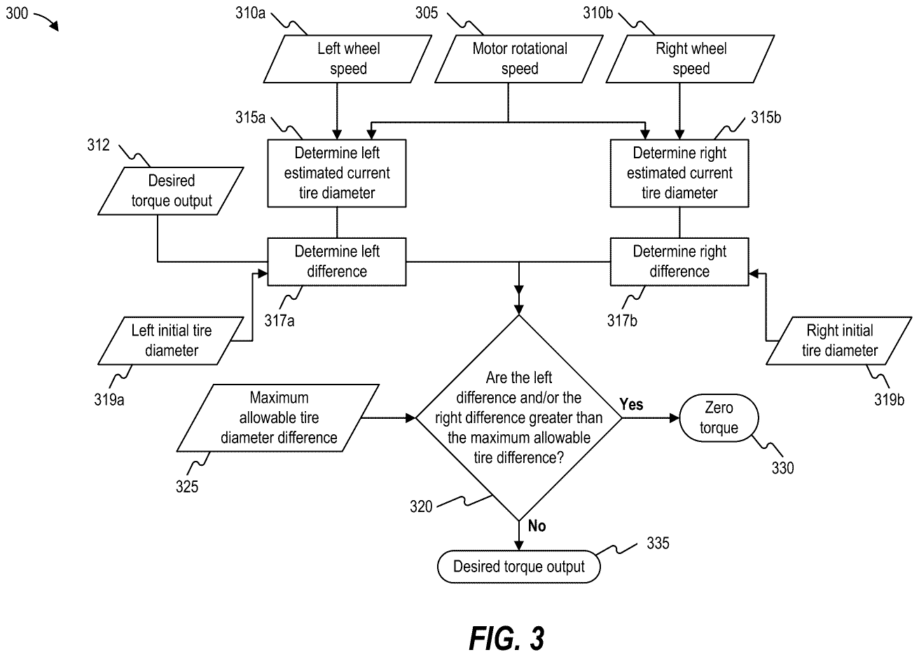

In some examples, the desired torque outputs for each of the first, second, and m^{th} motors can be adjusted by performing the method 300 of FIG. 3, which is later described herein. In other words, in aspects the method 300 of FIG. 3 is used as block 245.

Turning briefly to block 251, in some aspects method 200 determines whether conditions are met for operating in a default mode, also referred to herein as a “fallback mode,” instead of the torque equalization mode. In some examples, the conditions for operating the motor vehicle powertrain in the default mode are not met at the beginning of the motor vehicle powertrain's life, and the conditions are only met if a subsequent event occurs. For example, a decision to switch from operating the motor vehicle powertrain in the torque equalization mode to operating the motor vehicle powertrain in the default mode can be based at least in part on a determination that a higher priority drivetrain request (e.g., safety or traction loss event) has occurred. In some examples, the decision to operate the motor vehicle powertrain in the default mode can be based on the efficiency (or estimated efficiency) of the motors; for example, it can be determined that the motor vehicle powertrain will operate in the default mode if it has been determined that it is more energy-efficient for a single drive axle assembly, rather than a plurality of drive axle assemblies, to output the total torque output request.

In some implementations, when operating in a single axle efficiency mode, the controller 190 selects which axle to power at least in part as a function of the torque integrals determined at block 225. For example, when two axles have substantially equal estimated efficiencies, the controller can bias selection toward the axle having the lower cumulative torque integral (i.e., the axle that has historically received less torque), thereby allowing single axle operation to continue the equalization trend while meeting the total torque output request. Conversely, when the difference in integral magnitudes is within a tolerance band, the controller can prioritize an axle with higher instantaneous efficiency while maintaining slow convergence of the torque integrals.

Responsive to conditions being met for operating in default mode, at block 250, a desired fallback torque for each drive axle assembly can be determined and requested. When operating in fallback mode, the torque outputs to each drive axle assembly are not actively compensating for differences in torque integrals. For example, values for the fallback torque outputs for each drive axle assembly can be received at blocks 253a, 253b, 253m. In some examples, the values for the fallback torque outputs are based on vehicle operating conditions and/or driver demand (or autonomous driving system demand). For example, although not specifically shown, fallback torques for each axle can be a function of total torque output request similar to that discussed above with regard to block 240.

As discussed, conditions for default mode being met include some event which makes it such that dynamic torque equalization is undesirable, impractical, and/or simply ineffective. An example includes a traction loss event. Accordingly, it is to be understood that all input signals of the methodology of FIG. 2A-2C are sent about every 10 milliseconds (or between about every 5-20 milliseconds), such that the entirety of the methodology is calculated every ˜10 milliseconds. Accordingly, an event like a traction loss event will be readily indicated, rendering conditions met for operating in default mode. Once the event is cleared (e.g., traction loss is no longer an issue), dynamic torque equalization mode can resume.

Returning to block 245, method 200 proceeds to block 248 where desired dynamic torques are requested, wherein the desired dynamic torques are determined as a function of blocks 235 and 245 as previously discussed. Provided that conditions are not met for operating in default mode, method 200 proceeds to block 254 where the method proceeds based on the desired dynamic torques. Alternatively, responsive to conditions being met for operating in default mode, method 200 proceeds from block 250 to block 254, where the method proceeds with the fallback torques.

At blocks 255a, 255b, 255m, the desired torque outputs (requested at block 248) or the fallback torque outputs (requested at block 250) for one or more of the first, second, and m^{th} motors can be compensated in a “compensatory action.” In some examples, the torque outputs for one or more of the first, second, and m^{th} motors can be compensated at blocks 255a, 255b, 255m based at least in part on its desired torque output or fallback torque output and a maximum torque output threshold for the motor (or drive axle assembly, for example one or more components in the geartrain). Torque compensation based at least in part on the maximum torque output threshold can occur, e.g., when the torque request/demand on the particular drive axle exceeds the maximum torque output threshold for that drive axle. The maximum torque output threshold can be determined at block 260 based on any combination of hardware, power, and/or energy restrictions. In some examples, the maximum torque output thresholds can be the same for each of the first, second, and m^{th} drive axles. In some examples, where the hardware, power requirements, or energy restrictions of the first, second, and m^{th} motors differ, one or more drive axles may have a different maximum torque output threshold.

It should be understood that the torque outputs for the first, second, and m^{th} motors can be compensated regardless of whether the motor vehicle powertrain is operating in the torque equalization mode or the default mode.

In some examples, if the requested torque output (for example, the desired torque output when the motor vehicle powertrain is operating in the torque equalization mode or the fallback torque output when the motor vehicle powertrain is operating in the default mode) allocated to a particular drive axle assembly exceeds a maximum torque output threshold for the motor of that drive assembly, the torque output of that drive axle assembly can be compensated to substantially match the maximum torque output threshold (or some preestablished torque value lesser than the maximum torque output threshold) instead of the torque output that was requested at blocks 248 or 250. At the torque compensation step for this drive axle assembly, an amount of torque exceeding the maximum torque output threshold can be allocated among one or more of the remaining drive axle assemblies. In some examples, the excess torque can be allocated among the remaining drive axle assemblies in proportion to their respective torque integrals, provided the reallocation of torque does not result in the maximum torque output threshold being exceeded on another axle. If so, torque output to each axle may be correspondingly compensated so that the total torque output request (received at block 240) is met as close as possible without any torque output exceeding the maximum torque output threshold for any particular axle.

In one illustrative example, a motor vehicle powertrain can include a first drive axle assembly, a second drive axle assembly, and a third drive axle assembly. The first drive axle assembly can have a maximum torque output threshold of 250 Newton-meters, while the second and third drive axle assemblies can each have a maximum torque output threshold of 500 Newton-meters. The desired torque outputs for the first, second, and third drive axle assemblies can be 400 Newton-meters, 200 Newton-meters, and 400 Newton-meters, respectively, for a total torque output request of 1000 Newton-meters. The torque output of the first drive axle assembly can be compensated first. Since the first drive axle assembly's 400 Newton-meter desired torque output exceeds its 250 Newton-meter maximum torque output threshold by 150 Newton-meters, the torque output of the first drive axle assembly can be compensated to match the maximum torque output threshold of 250 Newton-meters. The 750 Newton-meter difference of the total torque output request (1000 Newton-meters) and the amount of torque allocated to the first drive axle assembly (250 Newton-meters) can be sequentially allocated to the second drive axle assembly and the third drive axle assembly. Since there is a 1:2 ratio of desired torque splits between the second and third drive axle assemblies, 250 Newton-meters of torque can be allocated to the second drive axle assembly and 500 Newton-meters of torque can be allocated to the third drive axle assembly.

Torque compensation can be performed for each drive axle assembly. For example, torque compensation can be performed twice for a powertrain with two drive axle assemblies, thrice for a powertrain with three drive axle assemblies, etc. Conducting the torque compensation step for each drive axle assembly can help ensure that the allocation of excess torque does not result in any motor associated with any drive axle assembly exceeding its predetermined torque output threshold.

In some examples where the compensated drive axle assembly includes a plurality of motors connected to a single drive axle, the plurality of motors can be configured to collectively output an amount of torque equal to the desired torque output or fallback torque output for that drive axle assembly. The torque can be divided equally or unequally among the plurality of motors according to any suitable algorithm.

Thus, it should be understood from the above description that, first, torque compensation is beneficial because it helps ensure that the total torque output request is satisfied regardless of the motor vehicle powertrain's operating mode and, second, torque compensation is performed regardless of whether the motor vehicle powertrain is operating in the torque equalization mode or the default mode.

Proceeding along, at blocks 265a, 265b, 265m, method 200 determines whether to decouple a corresponding one of the drive axle assemblies. As used herein, a decouple request refers to a request to decouple the motor (or plurality of motors) from a drive axle of a drive axle assembly, such that torque cannot be transferred from the motor to the drive axle. In some examples, the decouple request can be a command or instruction to place a drive axle assembly in a neutral gear or for the motor(s) of the drive axle assembly to output zero torque. In some of these examples, one or more drive axle assemblies can be selected for decoupling based on the corresponding torque integral for the drive axle assembly. In the illustrated example, a request to decouple a desired number of axles can be received at block 269. The desired number of axles can be in a range from zero axles to m axles. Responsive to the request, the first, second, or m^{th} drive axles can be decoupled at blocks 270a, 270b, 270m. In some examples, the request can include a desired number of axles to decouple. In some examples, the request can include information identifying specific axle(s) to decouple.

Returning briefly to block 267, method 200 can sort axles from highest torque integral to lowest torque integral, based on the torque integrals calculated at block 225. For example, an axle that has received the most torque as determined from the calculated torque integrals would be ranked first, and an axle that has received the lowest amount of torque as determined from the calculated torque integrals would be ranked last. This information can be relied upon for determining which axle(s) to decouple. For example, in a situation where there are three axles, which we term first, second, and third axles in this example, assuming the second axle has the highest torque integral, the third axle has the second highest torque integral, and the first axle has the third highest torque integral, the sorting is as follows: second axle first, third axle second, and first axle third. If the request at block 269 is to decouple 2 axles, then the axles that would be selected for decoupling include the second axle and the third axle, because those have the highest torque integrals as compared to the first axle. In a situation where the request at block 269 is to decouple just a single axle, then the methodology would select the second axle for decoupling, since it has the greatest torque integral.

For the drive axles that have not been decoupled, the torque outputs can be provided to the first, second, and m^{th} motors at blocks 275a, 275b, 275m in a manner such that a total torque output request (e.g., from a driver of the vehicle or an autonomous controller) is met. Accordingly, the controller of the vehicle can reallocate torque scheduled to be sent to an axle that is targeted for decoupling, to remaining axle(s), provided maximum torque output threshold for each drive axle assembly is not exceeded. In some examples where at least one of the drive axle assemblies includes a plurality of motors coupled to a single drive axle, the torque output for the drive axle assembly can be allocated among the plurality of motors.

Controlling a motor vehicle powertrain using the method 200 can beneficially substantially or fully equalize the amount of torque applied to the different drive axles over time, which can promote more uniform component wear (for example, more uniform tire tread wear). This can help reduce the frequency at which an operator need bring the motor vehicle in for service to rotate or replace a tire or tires, save cost, improve vehicle operational efficiency, and so on.

Turning to FIG. 3, a method 300 includes inferring the diameters of left and right wheels of a drive axle assembly and determining the amount of torque to apply to the wheels, according to an example. As previously discussed, the method 300 can be performed as part of one or more steps executed in the method 200 of FIGS. 2A-C. For example, the method 300 can be performed at block 245 of FIG. 2A.

The method 300 may be defined by instructions stored in a memory of the controller, which, when executed, cause the controller to carry out the depicted steps of the methodology. The method includes dividing the ground speed(s) of a set of wheels on a same axle (i.e., left wheel and right wheel on a drive axle of a drive axle assembly) by the rotational speed(s) of one or more motors of the drive axle assembly which the set of wheels are coupled thereto, to determine an estimated current tire diameter for one or more wheels (for example, each wheel) of the drive axle assembly. If a difference between the estimated current tire diameter and an initial tire diameter exceeds a maximum allowable tire diameter difference, the amount of torque applied to the wheel(s) of the drive axle assembly can be reduced (for example, set to zero) to proactively reduce or avoid further unequal tire wear.

Each drive axle assembly (which can be similar to independent drive axle assemblies 110a, 110b shown in FIG. 1) can include a motor (for example, one of motors 120a, 120b), a drive axle (for example, one of drive axles 140a, 140b) coupled to the motor, and a set of one or more wheels (for example, one of the sets of wheels 150a, 150b) coupled to the drive axle. Although the method 300 is described with respect to a drive axle assembly with a set of two wheels (e.g., a left wheel and a right wheel) coupled to the drive axle, other exemplary sets of wheels can include one, three, four, five, six seven, eight, nine, ten, or more wheels coupled in any arrangement to the drive axle. In some examples, the drive axle assembly can include a plurality of motors configured to impart torque on the drive axle. In some examples, one or more controllers (for example, the controller 190) can store and/or process computer-readable instructions for executing the method 300.

At block 305, the rotational speed of the motor can be measured. The rotational speed of the motor can be measured using a motor speed sensor (for example, one of motor speed sensors 170a, 170b). In some examples where the drive axle assembly includes more than one motor coupled to the drive axle, the rotational speed of any combination of these motors (for example, each motor) can be measured. In some examples where the drive axle assembly includes more than one motor coupled to the drive axle, the average speed of the motors can be provided at block 305. However, depending on the internal layout of the drive axle assembly, the average speed of the motors is not provided at block 305. For example, the average speed of the motors is not provided at block 305 if the drive axle assembly includes motors having different gear ratios coupled to the same drive axle.

At blocks 310a, 310b, the ground speed of the left wheel and the ground speed of the right wheel can be estimated, respectively. The ground speed of the left and right wheels can be estimated using data obtained from a wheel speed sensor (e.g., wheel speed sensor 180a). In some examples where the particular drive axle assembly includes a different number of wheels, the ground speed of any combination of these wheels (for example, each wheel) can be estimated.

At block 315a, an estimated current tire diameter (“left estimated current tire diameter”) of the left wheel can be determined. Discussed here in relation to method 300, the “left” wheel refers to a first wheel, and the “right” wheel refers to a second wheel, wherein both the left and right wheels are coupled to the same axle assembly. In some aspects, the left estimated current tire diameter can be determined by dividing the estimated current ground velocity of the left wheel by the rotational speed of the motor, and further dividing the quotient by the corresponding gear ratio between the motor and the left wheel. Similarly, at block 315b, an estimated tire diameter (“right estimated current tire diameter”) of the second wheel can be determined. For example, the second estimated current tire diameter can be determined by dividing the estimated current ground velocity of the right wheel by the rotational speed of the motor, and further dividing the quotient by the corresponding gear ratio between the motor and the right wheel. The estimated current tire diameter (d_{i,est}) of the i^{th} wheel (for example, either the left wheel or the right wheel) is given below by Equation 4:

$${d}_{i , est} = \frac{2 {v}_{i} {ϕ}_{i}}{ω} \qquad ( 4 )$$

wherein “νᵢ” is the estimated current ground velocity of the wheel, “ω” is the rotational speed of the corresponding motor that drives the i^{th} wheel, and “φᵢ” is gear ratio between the i^{th} wheel and its corresponding motor.

At block 317a, a left difference between the left estimated current tire diameter and an initial tire diameter of the tire of the left wheel (“first/left initial tire diameter”), received at block 319a, can be determined. Similarly, at block 317b, a right difference between the right estimated current tire diameter and an initial tire diameter of the tire of the right wheel (“second/right initial tire diameter”), received at block 319b, can further be determined.

At block 320, it can be determined whether any one of the left difference or the right difference exceeds a maximum allowable tire diameter difference (which is also referred to herein as a “maximum allowable tire diameter difference threshold”), which is provided as an input at block 325. The threshold can be a predefined, user selected, or calculated value. If at least one of the left difference and the right difference exceeds the maximum allowable tire diameter difference, the method can proceed to block 330, where a request to the motor(s) associated with the particular axle to output zero torque can be generated. Otherwise, the method can proceed to block 335, where a request to the motor to output the desired torque output (provided as an input at block 312) can be generated. In some examples, the desired torque output provided at block 312 can be equal to the outputs requested at block 245 of FIG. 2A-2C (which may be further adjusted or compensated during later stages of the method of FIG. 2A-2C). In some examples where the drive wheel assembly includes a different number of wheels and corresponding tires, it can be determined whether the difference between the initial and estimated current diameters of any tire can be measured.

Since a difference between an initial tire diameter and an estimated tire diameter can be indicative of excessive tire tread wear, reducing the torque applied to the axle if this difference exceeds a certain threshold can help proactively reduce the rate of future component wear (e.g., tire tread wear) relative to other components (e.g., wheels) of the motor vehicle.

In additional or alternative aspects, tire diameter for the tire of each wheel can be determined via a tire pressure monitoring system (TPMS), for example the TPMS 185 described and discussed above at FIG. 1 that relies on wheel speed differential to detect underinflated tires. Specifically, the TPMS can determine, for each drive axle assembly, the tire diameter for each wheel. Similar to that discussed with regard to FIG. 3, the data obtained from the TPMS can be compared, for each wheel, to initial wheel diameters, such that differences in initial and current tire diameters can be determined. Such information can be used in the manner described with regard to FIG. 3.

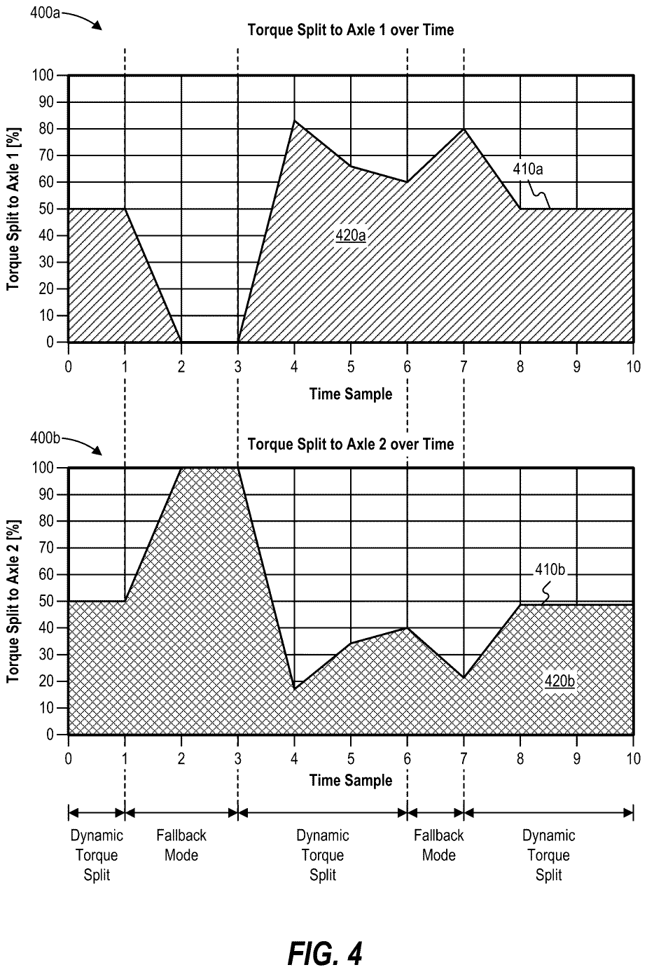

Referring to FIG. 4, first and second timelines 400a, 400b, include torques split to axle 1 or axle 2 over time, as a prophetic example. The first timeline 400a includes an exemplary first curve 410a representing the torque output (τ₁) of the first motor 120a over a time period spanning an initial time t₀ to a time/as the motor vehicle powertrain 100 operates in the torque equalization mode (also referred to herein as the “dynamic torque split mode”) or the default mode. (also referred to herein as the “fallback mode”) The area 420a under the first curve 410a is the first torque integral. Similarly, the second timeline 400b includes an exemplary second curve 410b representing the torque output (τ₂) of the second motor 120b over the same time period. The area 420b under the curve 410b is the second torque integral. When the motor vehicle powertrain 100 operates in the torque equalization mode, the first torque integral or area 420a and the second torque integral or area 420b will substantially equalize over time.

### Additional Examples of the Disclosed Technology

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. A method for operating a motor vehicle comprising a first drive axle assembly and a second drive axle assembly, the method comprising: determining a first torque integral of a first torque applied to a first drive axle of the first drive axle assembly by a first motor of the first drive axle assembly over a time period; determining a second torque integral of a second torque applied to a second drive axle of the second drive axle assembly by a second motor of the second drive axle assembly over the time period; generating a first torque output using the first motor of the first drive axle assembly; and generating a second torque output using the second motor of the second drive axle assembly, wherein the first and second torques are based at least in part on the first torque integral and the second torque integral.

Example 2. The method of any example herein, particularly Example 1, wherein: each of the first and second torque outputs are based on a relationship between the first torque integral and the second torque integral, and a total torque output request.

Example 3. The method of any example herein, particularly Example 2, wherein: the first torque is equal to the total torque output request, multiplied by an inverse of a sum of a first reciprocal of the first torque integral and a second reciprocal of the second torque integral, divided by the first torque integral, and the second torque is equal to the total torque output request, multiplied by the inverse of the sum of the first reciprocal and the second reciprocal, divided by the second torque integral.

Example 4. The method of any example herein, particularly any one of Examples 1-3, wherein the first torque output is selected so as to not exceed a first maximum torque output threshold of the first motor of the first drive axle assembly; and wherein the second torque output is selected to as to not exceed a second maximum torque output threshold of the second motor of the second drive axle assembly.

Example 5. The method of any example herein, particularly Example 4 further comprising, responsive to a first torque output request exceeding the maximum torque output threshold of the first motor of the first drive axle assembly, adjusting the first torque output request to arrive at the first torque output that is lesser than or equal to the maximum torque output threshold of the first motor of the first drive axle assembly, and transferring a remaining torque to the second drive axle assembly to arrive at the second torque output, or vice versa.

Example 6. The method of any example herein, particularly any one of Examples 1-5, wherein: the first drive axle assembly comprises a first set of wheels, the second drive axle assembly comprises a second set of wheels, each of the first set of wheels and the second set of wheels comprises a plurality of wheels each having a tire, and at least one of the first torque output and the second torque output are adjusted based on a first estimated current tire diameter of a first tire in the first set of wheels and a second estimated current tire diameter of a second tire in the second set of wheels, respectively.

Example 7. The method of any example herein, particularly any one of Examples 1-6 further comprising, prior to outputting the first torque and the second torque, determining whether a compensatory action is requested, and if so, commanding the compensatory action.

Example 8. The method of any example herein, particularly any one of Examples 1-7, wherein the time period, over which the first torque integral and the second torque integral are determined, spans an initial time t0 to a final time equal to t−ts, wherein “t0” is an initial time, “t” is a current time, and “ts” is a sampling period.

Example 9. The method of any example herein, particularly Example 8, wherein ts is in a range from 10 milliseconds to 20 milliseconds.

Example 10. The method of any preceding clause, wherein t0 is the time of a beginning of a life of the motor vehicle, a last tire replacement, or a last qualifying maintenance event.

Example 11. The method of any preceding clause, wherein the motor vehicle is an autonomous motor vehicle.

Example 12. A method of controlling a motor vehicle powertrain comprising: operating the motor vehicle powertrain in a dynamic torque split mode where a first torque output via a first motor to a first drive axle and a second torque output via a second motor to a second drive axle comprise torque outputs; and responsive to an indication that a tire or tires associated with the first drive axle or the second drive axle have a tire diameter that is below a threshold tire diameter, controlling an operation of at least one of the first motor and the second motor as a function of which tire or tires have tire diameters below the threshold tire diameter.

Clause 13. The method of clause 12, further comprising, after operating the motor vehicle powertrain in the dynamic torque split mode and prior to controlling the operating of at least one of the first motor and the second motor, estimating tire diameters of tires coupled to wheels associated with each of the first drive axle and the second drive axle.

Clause 14. The method of any preceding clause, wherein the tire diameters of the tires are estimated based at least in part on a gear ratio between at least one of the first motor and the second motor, and the wheels.

Clause 15. The method of any preceding clause, wherein estimating the tire diameters of the tires coupled to the wheels associated with each of the first drive axle and the second drive axle comprises, for each wheel: estimating a current ground velocity of the wheel, wherein a corresponding motor is configured to impart torque onto the wheel, and wherein the wheel comprises a tire; and determining the tire diameter of the tire based at least in part on a current rotational speed of the motor and the current ground velocity of the wheel.

Clause 16. The method of any preceding clause, wherein the torque outputs are based on a relationship between total torque applied to the first drive axle as compared to the second drive axle over a defined timeframe.

Clause 17. The method of any preceding clause, wherein controlling the operation of at least one of the first motor and the second motor as the function of which the tire or tires have tire diameters below the threshold tire diameter comprises requesting that at least one of the first motor and the second motor output zero torque to the drive axles with tires having tire diameters below the threshold tire diameter.

Clause 18. The method of any preceding clause, wherein: the method further comprises receiving a request for a compensatory action including a total torque output request, and controlling the operation of at least one of the first motor and the second motor as a function of which tire or tires have tire diameters below the threshold tire diameter comprises requesting that at least one of the first motor and the second motor output a non-zero torque to the drive axles with tires having tire diameters below the threshold tire diameter, such that the torque applied to the first drive axle and the second drive axle satisfies the total torque output request.

Example 19. A system comprising: a first drive axle assembly; a second drive axle assembly; and a controller storing instructions in non-transitory memory that, when executed, cause the controller to: allocate a first torque output to a first drive axle of the first drive axle assembly and a second torque output to a second drive axle of the second drive axle assembly as a function of total torque applied to the first drive axle over a predetermined time period and total torque applied to the second drive axle over the predetermined time period, such that a difference between the total torque applied to the first drive axle and total torque applied to the second drive axle is minimized over time.

Example 20. The system of any example herein, particularly Example 19, wherein the first drive axle assembly includes at least one first motor configured to apply the first torque output to the first drive axle; and the second axle drive assembly includes at least one second motor configured to apply the second torque output to the second drive axle.

Example 22. The system of any example herein, particularly Clause 21, wherein at least one of the at least one first motor and the at least one second motor can include a plurality of motors.

Example 23. The system of any example herein, particularly any one of Examples 19-22, wherein the system can be a motor vehicle.

Example 24. The system of any example herein, particularly Example 23, wherein the system can be an autonomous motor vehicle.

Example 25. A system for a vehicle can include a first drive axle assembly, a second drive axle assembly, and a controller storing instructions in non-transitory memory that, when executed, can cause the controller to: determine a first torque integral of torque applied to a first drive axle of the first drive axle assembly, determine a second torque integral of torque applied to a second drive axle of the second drive axle assembly, compare the first torque integral to the second torque integral, and determine a first desired dynamic torque output to the first drive axle and determine a second desired dynamic torque output to the second drive axle based on the comparison, and a total torque output request.

Example 26. The system of any example herein, particularly Example 25, wherein the first drive axle assembly can include a first motor configured to apply torque to the first drive axle and wherein the second drive axle assembly can include a second motor configured to apply torque to the second drive axle; and wherein the controller can store further instructions to control the first motor and the second motor based on the comparison of the first torque integral and the second torque integral.

Example 27. The system of any example herein, particularly any one of Examples 25-26, wherein the controller can store further instructions to: compare the first desired dynamic torque output to a first maximum torque output threshold and compare the second desired dynamic torque output to a second maximum torque output threshold, and limit torque applied to the first drive axle and to the second drive axle such that neither the first maximum torque output threshold nor the second maximum torque output threshold is exceeded.

Example 28. The system of any example herein, particularly Example 27, wherein the controller can store further instructions to: reallocate torque to the first drive axle when the second desired dynamic torque output exceeds the second maximum torque output threshold, or reallocate torque to the second drive axle when the first desired dynamic torque output exceeds the first maximum torque output threshold.

Example 29. The system of any example herein, particularly Example 28, wherein the controller can store further instructions to: reallocate torque to the first drive axle or the second drive axle in a manner that fulfills the total torque output request.

Example 30. The system of any example herein, particularly any one of Examples 25-29, wherein the controller can store further instructions to: in response to a request to operate the system in a default mode of operation, temporarily abort operating the system in a dynamic torque equalization mode in which the first and the second dynamic torque outputs are determined based on the comparison of the first torque integral and the second torque integral, and operate the system in the default mode of operation.

Example 31. The system of any example herein, particularly Example 30, wherein the controller can store further instructions to: request the default mode of operation in response to a qualifying event for operating the system in the default mode of operation.

Example 32. The system of any example herein, particularly Example 31, wherein the qualifying event can be a loss of traction event, or another event where operating in the dynamic torque equalization mode is not energy efficient or not practical from a safety standpoint.

Example 33. The system of any example herein, particularly any one of Examples 30-32, wherein the controller can store further instructions to: when operating the system in the dynamic torque equalization mode or the default mode, decouple at least one drive axle.

Example 34. The system of any example herein, particularly Example 33, wherein the controller can store further instructions to: decouple the first drive axle if the first torque integral is greater than the second torque integral, and decouple the second drive axle if the second torque integral is greater than the first torque integral.

Example 35. The system of any example herein, particularly any one of Examples 25-34, wherein the controller can store further instructions to: for each of the first and the second drive axle assemblies, determine a current tire diameter for each tire coupled to each drive axle, compare the current tire diameter to an initial tire diameter, and responsive to a difference in the current tire diameter and the initial tire diameter exceeding a predetermined maximum allowable tire difference threshold, discontinue sending torque to the drive axle for which the difference in the current tire diameter and the initial tire diameter exceeds the predetermined maximum allowable tire difference threshold.

Example 36. A method for operating a powertrain of a vehicle can include: operating the powertrain a dynamic torque equalization mode and, responsive to a request to operate the powertrain in a default mode of operation, temporarily exiting the dynamic torque equalization mode and operating the powertrain in the default mode of operation.

Example 37. The method of any example herein, particularly Example 36, wherein the dynamic torque equalization mode can be a mode in which torque applied to each axle of the powertrain is a function of a comparison of total torque applied to each axle over a predetermined timeframe, such that a difference in total torque applied to each axle over the predetermined timeframe is minimized.

Example 38. The method of any example herein, particularly any one of Examples 36-37, can further include: resuming operating the powertrain in the dynamic torque equalization mode responsive to conditions being met for resuming the dynamic torque equalization mode.

Various implementations or features may have been presented in terms of systems that may include a number of devices, components, modules, and the like. A person skilled in the art should understand and appreciate that the various systems may include additional devices, components, modules, etc. and/or may not include all of the devices, components, modules etc. discussed in connection with the figures. A combination of these approaches may also be used.

While implementations of the present disclosure have been described in connection with examples thereof, it will be understood by those skilled in the art that variations and modifications of the implementations described above may be made without departing from the scope hereof. Other implementations will be apparent to those skilled in the art from a consideration of the specification or from a practice in accordance with examples disclosed herein.

For purposes of this description, certain aspects, advantages, and novel features of the aspects of this disclosure are described herein. The disclosed methods, apparatus, and systems should not be construed as being limiting in any way. Instead, the present disclosure is directed toward all novel and nonobvious features and aspects of the various disclosed aspects, alone and in various combinations and sub-combinations with one another. The methods, apparatus, and systems are not limited to any specific aspect or feature or combination thereof, nor do the disclosed aspects require that any one or more specific advantages be present or problems be solved. The scope of this disclosure includes any features disclosed herein combined with any other features disclosed herein, unless physically impossible.

Although the operations of some of the disclosed aspects are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

As used in this disclosure and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In the description, certain terms may be used such as “forward,” “front,” “rear,” “up,” “down,” “upper,” “lower,” “horizontal,” “vertical,” “left,” “right,” and the like. These terms are used, where applicable, to provide some clarity of description when dealing with relative relationships. But these terms are not intended to imply absolute relationships, positions, and/or orientations. For example, with respect to an object, an “upper” surface can become a “lower” surface by turning the object over. Nevertheless, it is still the same object.

Similar components in different aspects are described in the specification and illustrated in the figures with similar reference numbers for improved understanding and readability. However, it should be understood that this numbering convention is merely for convenience and is not intended to limit and/or exclude any claim scope.

Although there are alternatives for various components, parameters, operating conditions, etc., set forth herein, that does not mean that those alternatives are necessarily equivalent and/or perform equally well. Nor does it mean that the alternatives are listed in a preferred order unless stated otherwise.

What is claimed is:

1. A system for operating a motor vehicle comprising:
a first drive axle assembly;
a second drive axle assembly; and
a controller storing instructions in non-transitory memory that, when executed, cause the controller to:
determine a first torque integral of a first torque applied to a first drive axle of the first drive axle assembly by a first motor of the first drive axle assembly over a time period;
determine a second torque integral of a second torque applied to a second drive axle of the second drive axle assembly by a second motor of the second drive axle assembly over the time period;
generate a first torque output using the first motor of the first drive axle assembly; and
generate a second torque output using the second motor of the second drive axle assembly,
wherein the first torque output and the second torque output are based at least in part on the first torque integral and the second torque integral.

2. The system of claim 1, wherein:
each of the first torque output and the second torque output are based on a relationship between the first torque integral and the second torque integral, and a total torque output request.

3. The system of claim 2, wherein:
the first torque is equal to the total torque output request, multiplied by an inverse of a sum of a first reciprocal of the first torque integral and a second reciprocal of the second torque integral, divided by the first torque integral, and
the second torque output is equal to the total torque output request, multiplied by the inverse of the sum of the first reciprocal and the second reciprocal, divided by the second torque integral.

4. The system of claim 3, wherein the first torque output is selected so as to not exceed a first maximum torque output threshold of the first motor of the first drive axle assembly; and
wherein the second torque output is selected to as to not exceed a second maximum torque output threshold of the second motor of the second drive axle assembly.

5. The system of claim 4, wherein the controller stores further instructions to: responsive to a first torque output request exceeding the first maximum torque output threshold of the first motor of the first drive axle assembly, adjust the first torque output request to arrive at the first torque output that is lesser than or equal to the first maximum torque output threshold of the first motor of the first drive axle assembly, and transfer a remaining torque to the second drive axle assembly to arrive at the second torque output, or vice versa.

6. The system of claim 5, wherein:
the first drive axle assembly comprises a first set of wheels,
the second drive axle assembly comprises a second set of wheels,
each of the first set of wheels and the second set of wheels comprises a plurality of wheels each having a tire, and
at least one of the first torque output and the second torque output are adjusted based on a first estimated current tire diameter of a first tire in the first set of wheels and a second estimated current tire diameter of a second tire in the second set of wheels, respectively.

7. The system of claim 6, wherein the controller stores further instructions to: prior to output of the first torque output and the second torque output, determine whether a compensatory action is requested, and if so, command the compensatory action.

8. The system of claim 7, wherein the time period, over which the first torque integral and the second torque integral are determined, spans an initial time t₀ to a final time equal to t−tₛ, wherein “t₀” is an initial time, “f” is a current time, and “tₛ” is a sampling period.

9. The system of claim 8, wherein tₛ is in a range from 10 milliseconds to 20 milliseconds.

10. The system of claim 9, wherein to is a time of a beginning of a life of the motor vehicle, a last tire replacement, or a last qualifying maintenance event.

11. The system of claim 1, wherein the motor vehicle is an autonomous motor vehicle.

12. A method of controlling a motor vehicle powertrain, comprising:
operating the motor vehicle powertrain in a dynamic torque split mode where a first torque output via a first motor to a first drive axle and a second torque output via a second motor to a second drive axle comprise torque outputs; and
responsive to an indication that a tire or tires associated with the first drive axle or the second drive axle have a tire diameter that is below a threshold tire diameter, controlling an operation of at least one of the first motor and the second motor as a function of which tire or tires have tire diameters below the threshold tire diameter.

13. The method of claim 12, further comprising, after operating the motor vehicle powertrain in the dynamic torque split mode and prior to controlling the operation of at least one of the first motor and the second motor, estimating the tire diameters of the tires coupled to wheels associated with each of the first drive axle and the second drive axle.

14. The method of claim 13, wherein the tire diameters of the tires are estimated based at least in part on a gear ratio between at least one of the first motor and the second motor, and the wheels.

15. The method of claim 13, wherein estimating the tire diameters of the tires coupled to the wheels associated with each of the first drive axle and the second drive axle comprises, for each wheel:
estimating a current ground velocity of a respective wheel, wherein a corresponding motor is configured to impart torque onto the respective wheel, and wherein the respective wheel comprises a respective tire; and
determining the tire diameter of the respective tire based at least in part on a current rotational speed of the corresponding motor and the current ground velocity of the respective wheel.

16. The method of claim 12, wherein the torque outputs are based on a relationship between total torque applied to the first drive axle as compared to the second drive axle over a defined timeframe.

17. The method of claim 12, wherein controlling the operation of at least one of the first motor and the second motor as the function of which tire or tires have the tire diameters below the threshold tire diameter comprises requesting that at least one of the first motor and the second motor output zero torque to the drive axles with the tires having the tire diameters below the threshold tire diameter.

18. The method of claim 12, further comprising:
receiving a request for a compensatory action including a total torque output request, and
controlling the operation of at least one of the first motor and the second motor as the function of which tire or tires have the tire diameters below the threshold tire diameter comprises requesting that at least one of the first motor and the second motor output a non-zero torque to the drive axles with the tires having the tire diameters below the threshold tire diameter, such that the torque applied to the first drive axle and the second drive axle satisfies the total torque output request.

19. A system comprising:
a first drive axle assembly;
a second drive axle assembly; and
a controller storing instructions in non-transitory memory that, when executed, cause the controller to:
allocate a first torque output to a first drive axle of the first drive axle assembly and a second torque output to a second drive axle of the second drive axle assembly as a function of total torque applied to the first drive axle over a predetermined time period and total torque applied to the second drive axle over the predetermined time period, such that a difference between the total torque applied to the first drive axle and the total torque applied to the second drive axle is minimized over time.

20. The system of claim 19, wherein the first drive axle assembly includes at least one first motor configured to apply the first torque output to the first drive axle; and
the second axle drive assembly includes at least one second motor configured to apply the second torque output to the second drive axle.
